(19) United States
(12) Patent Application Publication
(10) Pub. No.: US 2014/0052708 A1
(43) Pub. Date: Feb. 20, 2014

(54) USER CUSTOMIZED DATA PAGE FOR SEARCH ENGINE DATA

(71) Applicant: Martin Luis Alonso Lago, Brooklyn, NY (US)

(72) Inventor: Martin Luis Alonso Lago, Brooklyn, NY (US)

(73) Assignee: Conductor, Inc., New York, NY (US)

(21) Appl. No.: 13/586,481

(22) Filed: Aug. 15, 2012

(51) Int. Cl. G06F 17/30

(52) U.S. Cl. 707/709; 707/E17.108

(57) ABSTRACT

A system and method for generating search engine data to be displayed on a display. A processor may send search queries to a search engine and receive result sets in response. Search engine data may be generated for URLs based on the search queries and the result sets. Report data may be displayed on the display based on the search engine data. The report data may include data effective to display a raw data page based on the search engine data. The processor may receive a request message to modify the report data. The request message may include a request to generate a user customized data page including filtered data from the search engine data. The processor may generate modified report data in response to the request message. The modified report data includes data effective to display the raw data page and the user customized data page.

### BACKGROUND OF THE INVENTION

In a prior art search engine, a crawler aggregates pages from the Internet and ensures that these pages are searchable. The pages retrieved by the crawler are indexed by an indexer. For example, each web page may be broken down into words and respective locations of each word on the page. The pages are then indexed by the words and their respective locations. A user may send a search query to a dispatcher. The dispatcher may forward the query to search nodes. The search nodes search respective parts of the index and return search results along with a document identifier. The dispatcher merges the received results to produce a final result set displayed to a user sorted by ranking scores based on a ranking function. Users may modify web pages in an attempt to have their page appear higher in a result set for particular queries. This disclosure describes an improvement over these prior art technologies.

### SUMMARY OF THE INVENTION

One embodiment of the invention is a method for generating report data to be displayed on a display. The method may include, by a processor, sending search queries to a search engine. The method may further include receiving result sets from the search engine based on the search queries. The method may further include generating search engine data for URLs based on the search queries and the result sets. The method may further include generating report data to be displayed on the display based on the search engine data, the report data including data effective to display a raw data page based on the search engine data. The method may further include receiving a request message to modify the report data, the request message including a request to generate a user customized data page including filtered data from the raw data page. The method may further include generating modified report data in response to the request message. The modified report data may include data effective to display the raw data page and the user customized data page.

One embodiment of the invention is a system effective to generate report data to be displayed on a display. The system may include a memory including instructions and a processor in communication with the memory. The processor may be effective to send search queries to a search engine. The processor may receive result sets from the search engine based on the search queries. The processor may generate search engine data for URLs based on the search queries and the result sets. The processor may generate report data to be displayed on the display based on the search engine data, the report data including data effective to display a raw data page based on the search engine data. The processor may receive a request message to modify the report data, the request message including a request to generate a user customized data page including filtered data from the raw data page. The processor may generate modified report data in response to the request message, wherein the modified report data includes data effective to display the raw data page and the user customized data page.

One embodiment of the invention is a processor generated user interface on a display. The user interface may include a raw data page including search engine data, the search engine data being based on search queries, results sets produced by a search engine in response to the search queries and URLs. The user interface may include a user customized data page, the user customized data page including filtered data filtered from the raw data page.

### BRIEF DESCRIPTION OF THE FIGURES

The foregoing and other features of this disclosure will become more fully apparent from the following description and appended claims taken in conjunction with the accompanying drawings. Understanding that these drawings depict only some embodiments in accordance with the disclosure and are therefore not to be considered limiting of its scope, the disclosure will be described with additional specificity and detail by reference to the accompanying drawings in which:

FIG. 1 is a system drawing of a system in accordance with an embodiment of the invention.

FIG. 2 is a system drawing of a system in accordance with an embodiment of the invention.

FIG. 3 is a system drawing of a system in accordance with an embodiment of the invention.

FIG. 4 is a system drawing of a system in accordance with an embodiment of the invention.

FIG. 5 is a flow chart illustrating a process which could be performed in a accordance with an embodiment of the invention.

### DETAILED DESCRIPTION OF THE PREFERRED EMBODIMENT(S)

In the following detailed description, reference is made to the accompanying drawings which form a part thereof In the drawings, similar symbols typically identify similar components unless context indicates otherwise. The illustrative embodiments described in the detailed description, drawings and claims are not meant to be limiting. Other embodiments may be utilized and other changes may be made without departing from the spirit or scope of the subject matter presented herein. It will be readily understood that the aspects of the present disclosure as generally described herein and as illustrated in the accompanying figures can be arranged, substituted, combined, separated and/or designed in a wide variety of different configurations all of which are explicitly contemplated herein.

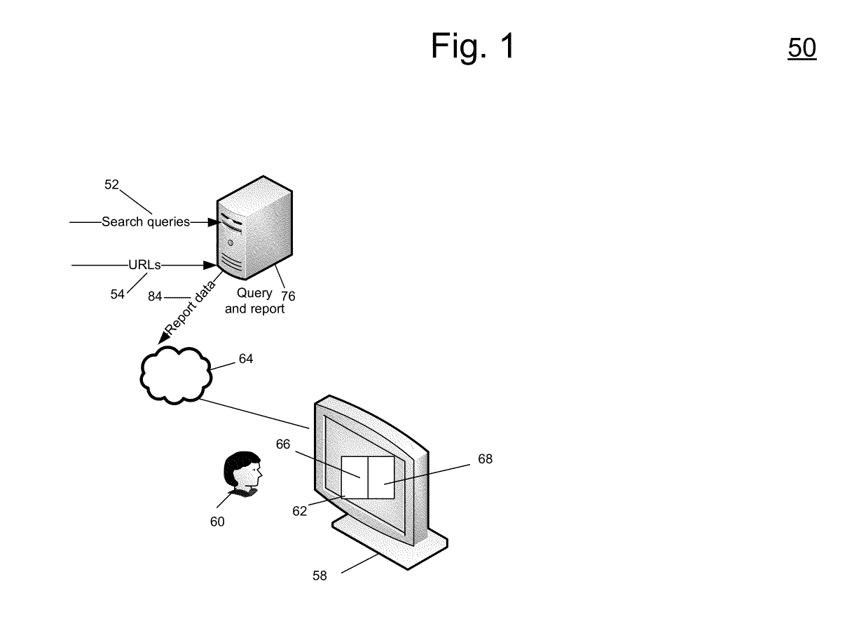

Referring to FIG. 1, there is shown a system 50 in accordance with an embodiment of the invention. A user 60 may provide search queries 52 and Uniform Resource Locators (URLs) 54 to a query and report processor 76. Each search query 52 could be, for example, one or more characters, symbols, phrases and/or words. URLs 54 may be addresses owned by user 60 and/or owned or operated by companies of interest to user 60 such as competitors of user 60.

Query and report processor 76 receives search queries 52 and URLs 54 and generates report data 84. Report data 84 may include search engine optimization data such as data indicating ranks of URLs 54 in result sets generated by a search engine for search queries 52. Report data 84 may be displayed as a report 62 to user 60 on a display 58. Query and report processor 76 may be in communication with user 60 and display 58 over a network 64 such as the Internet network. As discussed in more detail below, report 62 may include a raw data page 66, including unfiltered report data 84, and a user customized data page 68, including some of report data filtered by user 60.

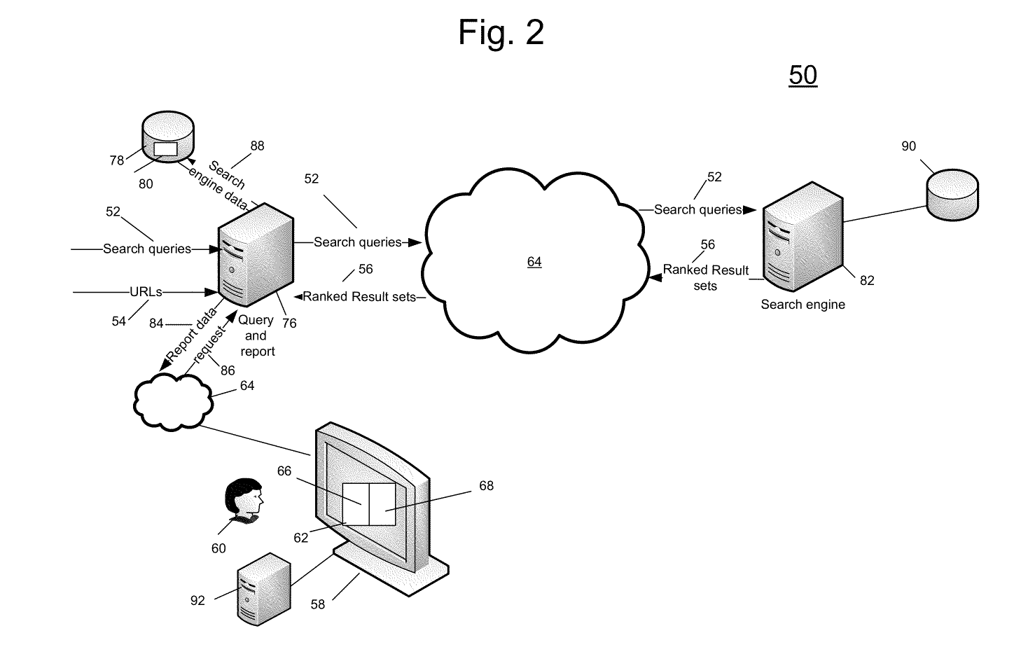

Referring to FIG. 2, query and report processor 76 may further be in communication with a memory 78 including instructions 80 and with a search engine 82 over network 64. Query processor 76 may receive search queries 52 and URLs 54 from user 60 or from another source. Search queries 52 could include, for example, search queries relevant to a business and/or web site owned by user 60. Query and report processor 76 may send each search query 52 over network 64 to search engine 82. The search engine could be, for example, the GOOGLE search engine, the YAHOO! search engine, the BING search engine, etc. Search engine 82 may receive search queries 52 and search a web index 90 of the search engine for web pages and corresponding URLs that may include each search query 52. Search engine 82 may generate result sets listing web pages and URLs that include respective search queries 52. Search engine 82 may then rank each of the URLs in the result sets to produce ranked result sets 56 and send ranked result sets 56 over internet 64 to query and report processor 76.

Query and report processor 76 may receive ranked result sets 56 and generate search engine data 88 to be stored in memory 78. Search engine data 88 may reflect where URLs 54 are ranked in ranked results sets 56 of search engine 82. Query and report processor 76 may use search engine data 88 to produce report data 84. Report data 84 may be processed to generate report 62 on display 58 such through processing by a processor 92. Processor 92 may be in the same housing as display 58 (such as in a tablet device) or in a different housing as display 58. As explained in more detail below, user 60 may send request messages 86 to query and report processor 76 including requests for modifications to report data 84. Query and report processor 76 may receive request messages 86, analyze search engine data 88, and generate modified report data 84 in response.

As mentioned above, report 62, generated based on report data 84, may include a raw data page 66 and a user customized data page 68. Raw data page 66 may correspond to search engine data 88. For example, raw data page 66 may include all data available for search queries 52, ranked result sets 56 and URLs 54 in search engine data 88 regardless of whether that data is relevant to user 60. User customized data page 68 may correspond to raw data from raw data page 66 filtered by user 60 using request message 86. Raw data page 66 may display valuable data for user 60. However, user 60 may be more interested in data focused on a business of user 60. User customized data page 68 may be a result of displayed raw data 66 filtered by user 60 to focus on a business of user 60.

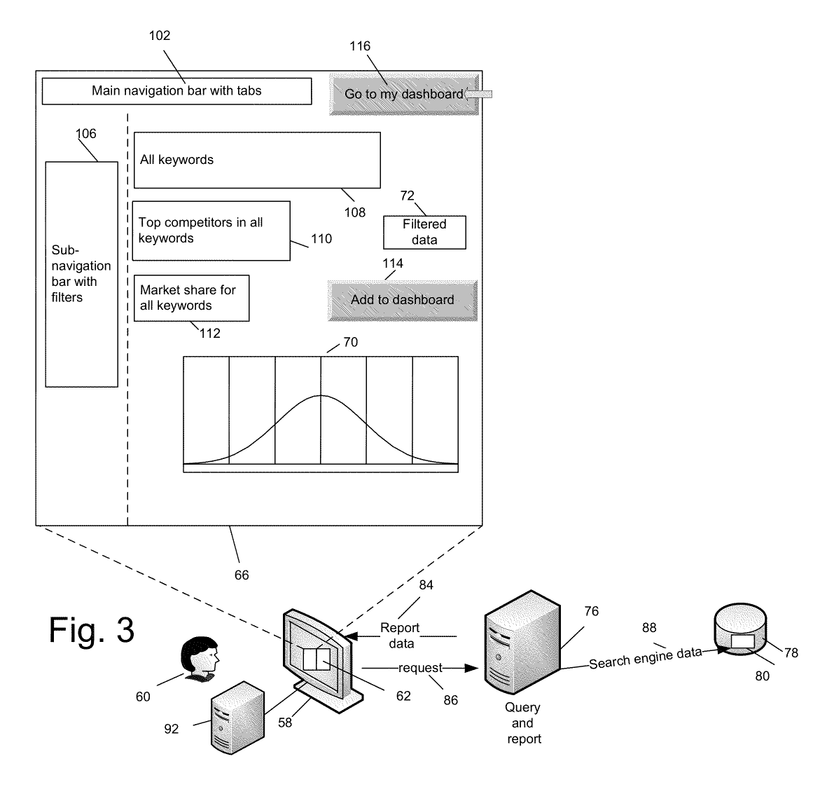

Referring to FIG. 3, raw data page 66 may include fields facilitating review and filtering of raw data by user 60. For example, raw data page 66 may include a main navigation bar with tabs 102, and a sub-navigation bar with filters 106. Examples of fields for raw data 66 may include all keywords 108, top competitors in all keywords 110, market share for all keywords 112, etc. Examples of tabs in main navigation bar with tabs 102 may include: home, categories, keywords, recommendations, opportunities, etc. Examples of sub-navigation bar with filters 106 may include category navigation, display options, filters, etc. Raw data page 66 may include charts 70 illustrating raw data displayed from report data 84. Raw data page 66 thus may provide valuable information regarding all search queries 52 entered by user 60 for all URLs 54.

User 60 may further be able to focus on certain information in search engine data 88 that is particularly valuable to a business of user 60. To facilitate this filtering, raw data page 66 may further include an “Add to dashboard” button 114 and a “Go to my dashboard” button 116. User 60 may use one of the filters in, for example, sub-navigation bar 106 to filter particular data of search engine data 88 to produce filtered data 72. For example, user 60 may use filters in sub-navigation bar 106 to view top competitors of a company of user 60 in all keywords entered in search queries 52. Once this filtered data 72 is displayed on raw data page 66, user 60 may select “Add to dashboard” button 114 to have filtered data 72 added to user customized data page 68. Similarly, user 60 may use filters to view links to, and links from, a company of user 60. Once this filtered data 72 is displayed on raw data page 66, user 60 may select “Add to dashboard” button 114 to have filtered data 72 added to user customized data page 68. User 60 could filter by, for example, keyword, rank, category, URL details, keyword details, links, category performance, competitor's performance, recommendations, new keyword opportunities, etc. A user could filter by keywords (e.g. containing or not containing a certain string), by rank, by category, by analytics metric, etc. User 60 may use request 86 to request that data be sorted by any field (such as order by volume in an ascending fashion), or alphabetically by keywords. User can also decide how many results to show in the filtered view: e.g. show only the top 20, or the top 40.

Pressing the “Add to dashboard” button 114, generates request message 86 that is sent to query and report processor 76. Request message 86 may include a request for query and report processor 76 to generate modified report data 84 so that user customized data page 68 includes filtered data 72. Pressing the “Go to my dashboard” button 116 allows user 60 to view user customized data page 68.

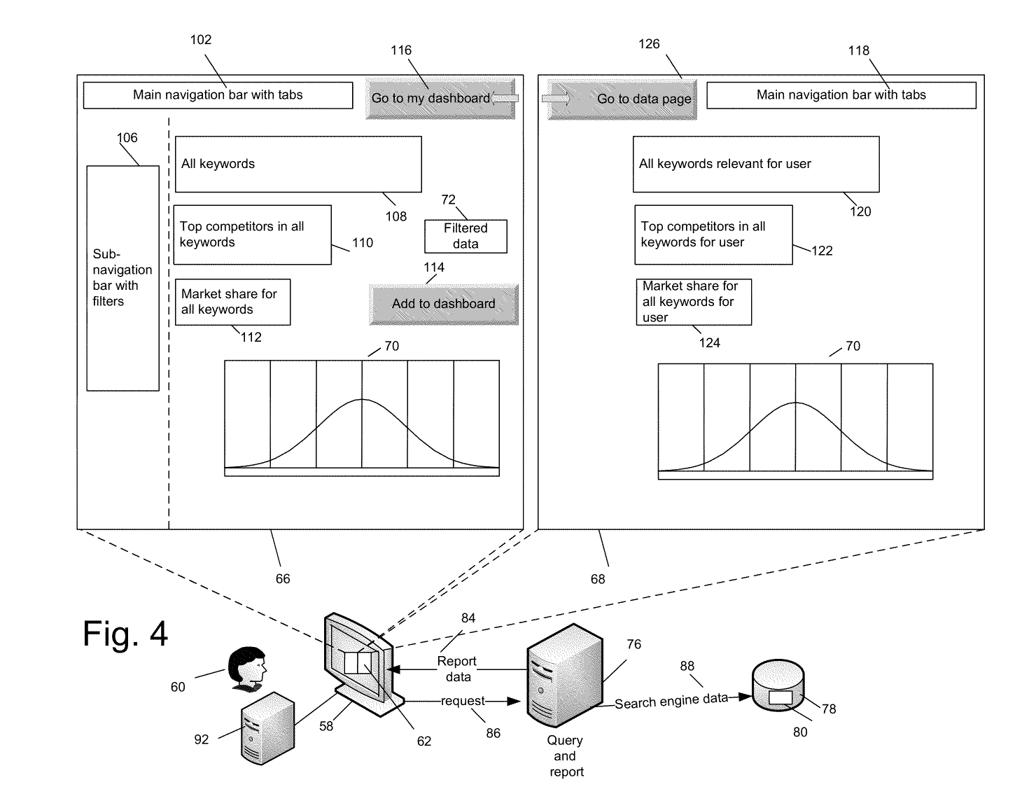

Referring to FIG. 4, user customized data page 68 may include a filtered view of search engine data 88. For example, user customized data page 68 may include a main navigation bar with tabs 118 and filtered data fields such as all keywords relevant for the user 120, top competitors in all keywords for user 122, market share for all keywords for user 124, etc. In the example shown, table 70 was also selected by user 70 for user customized data page 68. User customized data page 68 may be a comprehensive display of saved views by user 60 generated in response to request messages 86. Main navigation bar with tabs 118 may include an identification of user 60 indicating that page 68 corresponds to the user's requests, a dashboard tab, a reports tab, a goals tab, a tasks tab, an annotations tab, etc. These tabs may allow user 60 to perform other viewing operations relating to search engine data 88.

User 60 may modify a visual size or location of filtered data in page 68 as desired. After user 60 identifies a size or location for filtered data in user customized data page 68, processor 92 may generate request messages 86 requesting that query and report processor 76 generate modified report data 84 to reflect the requested size or location. In this way, the next time user 60 presses “Go to my dashboard” button 116, the same type filtered data may be displayed in the same location even if the underlying data itself has changed. For example, chart 70 may appear in the same location in user customized data page 68 but the chart itself may change to reflect changes in the underlying data. Pressing the “Go to data page” button 126 allows user 60 to view user raw data page 66.

User customized data page 68 may include a go to data page button 126. Go to data page button 126 and go to my dashboard button 116 enable user 60 to toggle back and forth between raw data in raw data page 66 and filtered user customized data in user customized data page 68. Report data 84 may include data effective to display both raw data page 66 and user customized data page 68. Alternatively, report data 84 may include data effective to display one of raw data page 66 or user customized data page 68. In response to request message 86 identifying that user 60 has pressed “Go to my dashboard” button 116 or “Go to data page” button 126, query and report processor 76 may update report data 84 to include data effective to display the other of raw data page 66 or user customized data page 68.

Among other benefits, a system in accordance with the disclosure provides a user with a customized dashboard including data relevant to the user's search engine optimization efforts. The user can see raw data on one page of the interface and the user's customized view on another page of the interface. The user may toggle between these two pages allowing the user to cross-reference the data.

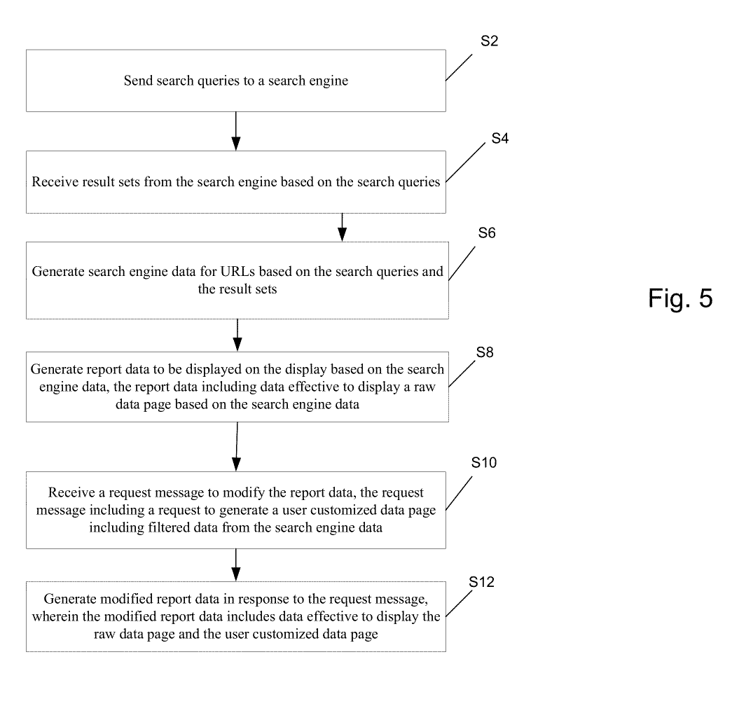

Referring to FIG. 5, there is shown a process which could be performed in accordance with an embodiment of the invention. The process could be performed using, for example, system 50 discussed above and may be used to generate a report to be displayed on a display. As shown, at step S2, a processor may send search queries to a search engine. At step S4, the processor may receive result sets from the search engine based on the search queries. At step S6, the processor may generate search engine data for URLs based on the search queries and the result sets. The URLs and search queries may be received from a user. At step S8, the processor may generate report data to be displayed on the display based on the search engine data. The report data may include data effective to display a raw data page based on the search engine data. The raw data page may include fields facilitating review and filtering of the raw data.

At step S10, the processor may receive a request message to modify the report data. The request message may include a request to generate a user customized data page including filtered data from the search engine data. The request may include a request to filter the data on the raw data page to produce filtered data at a particular size or location. At step S12, the processor may generate modified report data in response to the request message. The modified report data may include data effective to display the raw data page and the user customized data page. The processor may cause the modified report to be displayed as a report on the display. In response to a request to display the user customized data page, the processor may cause the user customized data page to be displayed on the display.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A method for generating report data to be displayed on a display, the method comprising, by a processor:
sending search queries to a search engine;
receiving result sets from the search engine based on the search queries;
generating search engine data for URLs based on the search queries and the result sets;
generating report data to be displayed on the display based on the search engine data, the report data including data effective to display a raw data page based on the search engine data;
receiving a request message to modify the report data, the request message including a request to generate a user customized data page including filtered data from the raw data page; and
generating modified report data in response to the request message, wherein the modified report data includes data effective to display the raw data page and the user customized data page.

2. The method of claim 1, further comprising causing the modified report data to be displayed as a report on the display.

3. The method of claim 1, further comprising:
causing the raw data page to be displayed on the display;
receiving a request to display the user customized data page; and
causing the user customized data page to be displayed on the display.

4. The method of claim 1, further comprising:
causing the raw data page to be displayed on the display;
receiving the request message to filter data on the raw data page to produce the filtered data and to display the user customized data page; and
wherein the modified report data includes data effective to display the user customized data page including the filtered data.

5. The method of claim 1, further comprising:
causing the raw data page to be displayed on the display;
receiving the request message to filter data on the raw data page to produce the filtered data and to display the filtered data on the user customized data page;
wherein the modified report data includes data effective to display the user customized data page including the filtered data;
receiving a request to display the user customized data page; and
causing the user customized data page to be displayed on the display.

6. The method of claim 1, further comprising receiving the URLs and the search queries from another processor.

7. The method of claim 1, wherein the raw data page includes fields facilitating review and filtering of the raw data.

8. The method of claim 1, wherein the request message includes a request to display the filtered data at a particular location on the user customized data page.

9. The method of claim 1, wherein the request message includes a request to display the filtered data at a particular size on the user customized data page.

10. A system effective to generate report data to be displayed on a display, the system comprising:
a memory including instructions;
a processor in communication with the memory, the processor effective to
send search queries to a search engine;
receive result sets from the search engine based on the search queries;
generate search engine data for URLs based on the search queries and the result sets;
generate report data to be displayed on the display based on the search engine data, the report data including data effective to display a raw data page based on the search engine data;
receive a request message to modify the report data, the request message including a request to generate a user customized data page including filtered data from the raw data page; and
generate modified report data in response to the request message, wherein the modified report data includes data effective to display the raw data page and the user customized data page.

11. The system of claim 10, wherein the processor is effective to cause the modified report data to be displayed as a report on the display.

12. The system of claim 10, wherein the processor is effective to:
cause the raw data page to be displayed on the display;
receive a request to display the user customized data page; and
cause the user customized data page to be displayed on the display.

13. The system of claim 10, wherein the processor is further effective to:
cause the raw data page to be displayed on the display;
receive the request message to filter data on the raw data page to produce the filtered data and to display the filtered data on the user customized data page; and
wherein the modified report data includes data effective to display the user customized data page including the filtered data.

14. The system of claim 10, wherein the processor is further effective to:
cause the raw data page to be displayed on the display;
receive the request message to filter data on the raw data page to produce the filtered data and to display the filtered data on the user customized data page;
wherein the modified report data includes data effective to display the user customized data page including the filtered data;
receive a request o display the user customized data page; and
cause the user customized data page to be displayed on the display.

15. The system of claim 10 wherein the processor is further effective to receive the URLs and the search queries from another processor.

16. The system of claim 10, wherein the raw data page includes fields effective to facilitate a review and filter of the raw data.

17. The system of claim 10, wherein the request message includes a request to display the filtered data at a particular location on the user customized data page.

18. The system of claim 10, wherein the request message includes a request to display the filtered data at a particular size on the user customized data page.

19. A processor generated user interface on a display, the user interface comprising:
a raw data page including search engine data, the search engine data being based on search queries, results sets produced by a search engine in response to the search queries and URLs; and
a user customized data page, the user customized data page including filtered data filtered from the raw data page.

20. The processor generated user interface as recited in claim 19, further comprising at least one button effective to generate a signal, the signal effective to produce a toggle between the raw data page and the user customized data page.
